(19) United States
(12) Patent Application Publication
(10) Pub. No.: US 2026/0088269 A1
(43) Pub. Date: Mar. 26, 2026

(54) DISSOLUTION-ASSISTED WETTING OF LITHIUM ONTO COPPER CURRENT COLLECTOR

(71) Applicant: GM GLOBAL TECHNOLOGY OPERATIONS LLC, Detroit, MI (US)

(72) Inventors: Diptak BHATTACHARYA, Royal Oak, MI (US); Shaomao XU, Sterling Heights, MI (US); Sayed Youssef Sayed NAGY, Troy, MI (US); Caleb REESE, Ferndale, MI (US); Yoojin KIM, Shelby Township, MI (US); Andrew Clay BOBEL, Troy, MI (US)

(21) Appl. No.: 18/897,804

(22) Filed: Sep. 26, 2024

(51) Int. Cl. H01M 4/04; C23C 2/04; H01M 4/02; H01M 4/134; H01M 4/1395

(52) U.S. Cl. CPC H01M 4/0404; C23C 2/04; H01M 4/134; H01M 4/1395; H01M 2004/021; H01M 2004/027

(57) ABSTRACT

A method for manufacturing an anode electrode for a battery cell includes melting lithium metal in a bath to create molten lithium metal; adding copper to the molten lithium metal in the bath to form a molten lithium matrix including lithium metal and distributed copper particles, wherein a concentration of the copper added to the bath comprises 5 wt % to 15 wt %; and coating a copper current collector using the molten lithium matrix to form an anode active material layer on the copper current collector.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to anode electrodes manufactured by dissolution wetting of lithium onto a copper current collector.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A method for manufacturing an anode electrode for a battery cell includes melting lithium metal in a bath to create molten lithium metal; adding copper to the molten lithium metal in the bath to form a molten lithium matrix including lithium metal and distributed copper particles, wherein a concentration of the copper added to the bath comprises 5 wt % to 15 wt %; and coating a copper current collector using the molten lithium matrix to form an anode active material layer on the copper current collector.

In other features, the method includes stirring the molten lithium matrix to create a homogenous mixture. The method includes stirring the molten lithium matrix using an electromagnetic stirrer. The anode electrode has a thickness that is less than 70 μm. The anode electrode has a width greater than 100 μm.

In other features, the method includes heating the bath to a temperature that is at least 100° C. greater than a melting temperature of lithium. The temperature of the bath is in a range from 290° C. to 310° C. The copper added to the bath is selected from a group consisting of copper foil, bronze foil, brass foil, and combinations thereof. The copper added to the bath includes copper foil. The copper current collector does not include a lithiophilic metallic/metal-oxide coating.

An anode electrode for a battery cell including an anode current collector comprising copper and an anode active material layer coated onto an outer surface of the anode current collector. The anode active material layer comprises a lithium matrix including lithium metal and distributed copper particles. The copper in the anode active material layer comprises 5 wt % to 15 wt % of the anode active material layer.

In other features, the distributed copper particles form copper dendrites in the lithium metal of the anode active material layer. The anode electrode has a thickness that is less than 70 μm, and the anode electrode has a width greater than 100 μm.

In other features, the anode current collector comprises copper foil. The anode current collector does not include a lithiophilic metallic/metal-oxide coating.

A battery cell comprises A of the anode electrode, C cathode electrodes, and S separators, where A, C and S are integers greater than one.

A method for manufacturing an anode electrode for a battery cell includes heating lithium metal in a bath to create molten lithium metal at a temperature that is at least 100° C. greater than a melting temperature of the lithium metal; and adding copper to the molten lithium in the bath to form a lithium matrix including distributed copper particles. The copper comprises in a range from 5 wt % to 15 wt % of the lithium matrix. The method includes stirring the lithium matrix in the bath using an electromagnetic stirrer; and coating a copper current collector using the lithium matrix in the bath to form an anode active material layer on the copper current collector. The temperature is in a range from 290° C. to 310° C.

In other features, the copper added to the bath is selected from a group consisting of copper foil, bronze foil, and brass foil. The anode electrode has a thickness that is less than 70 μm, and the anode electrode has a width greater than 100 μm.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including C cathode electrodes, A anode electrodes including copper anode current collectors and a lithium-copper metal coating, and S separators according to the present disclosure;

FIG. 2 is a side cross section of an example of a cathode electrode according to the present disclosure;

FIG. 3 is a side cross section of an example of an anode electrode including copper anode current collectors and a lithium-copper coating according to the present disclosure;

FIG. 4 is a side cross section of an example of lithium metal that has not wetted onto a copper anode current collector;

FIG. 5 is a graph illustrating an example of phases and solubility of mixtures of lithium and copper as a function of temperature and copper concentration;

FIG. 6 is a flowchart of an example of a method for wetting an anode current collector using a bath including a molten lithium matrix with lithium metal and distributed copper particles according to the present disclosure;

FIG. 7 is a side view illustrating an example of preparation of the bath including the molten lithium matrix with lithium metal and distributed copper particles according to the present disclosure;

FIG. 8 is a side view illustrating an example of manufacturing of anode electrodes by passing copper foil through the bath including molten lithium-copper according to the present disclosure;

FIG. 9A is an enlarged side section of the anode electrode according to the present disclosure;

FIG. 9B is an enlarged plan view of the lithium-copper layer according to the present disclosure;

FIG. 10A is a plan view of the pure lithium layer showing dendrite formation after lithium stripping and plating; and

FIG. 10B is a plan view of the lithium-copper layer after more uniform lithium stripping and plating according to the present disclosure.

In the drawings, reference numbers may be reused to identify similar and/or identical elements.

### DETAILED DESCRIPTION

While anode electrodes and battery cells according to the present disclosure are shown in the context of electric vehicles, the anode electrodes and battery cells can be used in stationary applications and/or other applications.

Lithium (Li) metal anode electrodes can deliver the highest theoretical specific capacity (˜3860 mAh/g) as compared to graphite at only 360 mAh/g. Conventional approaches for manufacturing lithium foil are typically based on extrusion and rolling. Manufacturing lithium foil by rolling is extremely challenging. The lithium foil needs to be sufficiently large and thin (e.g., less than 70 μm thick and wider than 100 mm) for large format battery cells. Poor mechanical properties of lithium (e.g., extreme softness) have prevented the use of rolling for these applications.

One method for manufacturing ultrathin lithium metal anodes involves coating a current collector foil with molten lithium. In practice, however, it is difficult to manufacture molten lithium anodes. Lithium has extremely low wettability onto commercial current collector substrates (such as copper foil, stainless steel foil, or 3D mesh current collectors). For example, spheres of molten lithium form when liquid lithium is coated onto untreated copper foil surfaces. Lithium does not adhere well to the copper which creates bare spots on the copper foil surface. Molten lithium also dissolves some of the copper from the copper foil causing fragmentation of the copper foil.

Efforts have been made to improve the wettability of molten lithium onto a copper current collector and/or to prevent dissolution of the copper foil current collector. These approaches typically require the copper current collector to be coated with a lithiophilic metallic/metal-oxide coating (such as Zn, Sn, Mg, their oxides, and combinations thereof). In some examples, the coating is added using an electroplating process. However, electroplating adds significant cost to the manufacturing process. In addition, it is difficult to uniformly deposit the lithiophilic coating to uniformly improve wetting and avoid copper dissolution across the entire surface area of the current collector.

Anode electrodes according to the present disclosure include a copper current collector that is dipped into a bath that is heated by a predetermined temperature delta of at least 100° C. above a melting temperature of the lithium (e.g., 170° C.). For example, the temperature of the bath can be held at approximately 300° C. (e.g., 290° C. to 310° C.). The bath includes molten lithium and copper. Copper is dissolved into the lithium bath to improve the wettability of molten lithium onto the copper current collector.

The solubility of copper in the lithium bath is relatively low at 300° C. For example, the solubility of copper in molten lithium is less than 0.1 wt % at 300° C. Copper is added to the molten lithium beyond the solubility limit of copper in molten lithium at the temperature of the bath. In some examples, the copper in the bath comprises 5 wt % to 15 wt % of the molten metal in the bath, which is significantly higher than the solubility of copper at this temperature. In some examples, lithium comprises 85 wt % to 95 wt %.

The addition of copper into the molten lithium bath creates a secondary metallic additive phase (an alloy of copper and lithium) which helps to reduce the surface energy of the lithium bath, and improve the wettability of molten lithium. Additionally, the molten lithium with the secondary copper-lithium additive phase prevents further dissolution of copper from the current collector foil.

The surface tension of the bath is reduced by allowing copper dissolution into the molten lithium bath. The meniscus shape of the applied coating changes from a sphere to a flat surface in response to the copper added to the molten lithium as described herein. Lithium wets onto the copper current collector spontaneously when the molten lithium bath includes the copper additive. Furthermore, the copper foil current collector did not fragment during coating in the bath.

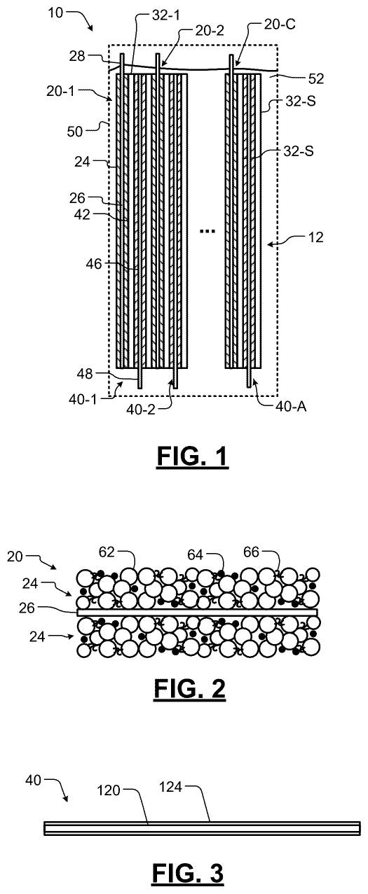

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. In some examples, liquid electrolyte 52 is added to the enclosure 50.

The C cathode electrodes 20-1, 20-2, . . . , and 20-C include a cathode active material layer 24 arranged on one or both sides of a cathode current collector 26. The A anode electrodes 40-1, 40-2, . . . , and 40-A include anode active material layers 42 arranged on one or both sides of the anode current collectors 46. The anode active material layers 42 include a lithium-copper layer that is coated by immersing the anode current collectors 46 in a lithium-copper bath including 5 wt % to 15 wt % copper as described herein. The anode current collectors 46 include copper current collectors. The S separators 32-1, 32-2, . . . , and 32-S are arranged between the C cathode electrodes 20 and the A anode electrodes 40.

In some examples, the A anode electrodes 40 and the C cathode electrodes 20 exchange lithium ions during charging/discharging. In some examples, the cathode active material layers 24 comprise coatings including one or more active materials, one or more conductive additives, and/or one or more binder materials that are cast or applied onto one or both sides of the cathode current collectors 26, respectively.

In some examples, the cathode current collectors 26 comprise metal foil, metal mesh, perforated metal, 3 dimensional (3D) metal foam, and/or expanded metal. In some examples, the cathode current collectors are made of one or more materials selected from a group consisting of stainless steel, brass, bronze, zinc, aluminum, and/or alloys thereof. External tabs 28 and 48 extend from the current collectors of the cathode electrodes and anode electrodes, respectively, and can be arranged on the same or different sides of the battery cell stack 12. The external tabs 28 and 48 are connected to terminals of the battery cells.

Referring now to FIG. 2, one of the C cathode electrodes 20 is shown in more detail. The cathode active material layer 24 includes a cathode active material 62, a conductive additive 64, and a binder 66.

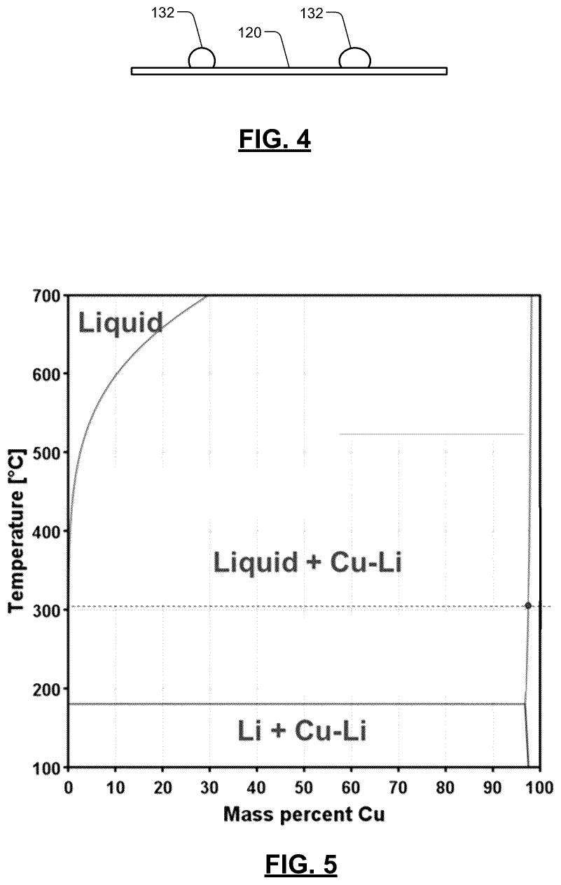

Referring now to FIG. 3, an anode electrode 40 includes a copper foil current collector 120 and an anode active material layer 124. The anode active material layer 124 is applied by passing the copper foil current collector 120 through a lithium-copper bath heated to a temperature greater than 270° C. (e.g., 300° C.). As noted above, it is difficult to wet the surface of the copper foil current collector 120 using pure molten lithium. In FIG. 4, when coating the copper foil current collector 120, a meniscus of pure lithium metal 132 that is coated onto the copper foil has a spherical shape rather than the desired flat surface corresponding to the anode active material layer.

According to the present disclosure, the copper foil current collector 120 is immersed in a bath including a molten lithium matrix including dissolved copper particles. The copper foil current collector 120 is coated to form the anode active material layer 124. In some examples, the anode active material layer 124 includes lithium metal in a range from 85 wt % to 95 wt % and copper in a range from 5 wt % to 15 wt %.

In FIG. 5, a graph shows phases and solubility of a bath including both lithium and copper at different temperatures and concentrations of copper. According to the present disclosure, copper is added to the lithium bath up to a copper solubility limit. Additional copper is added to form a concentration of copper in the molten lithium in a range from 5 wt % to 15 wt %. The concentration of copper in the bath is significantly greater than the solubility of copper at the heated temperature of the bath. The added copper improves wetting onto the copper foil current collector. Since the copper in the bath exceeds the solubility of copper, the added copper also reduces dissolution of the copper foil current collector (that would otherwise occur if pure molten lithium were used).

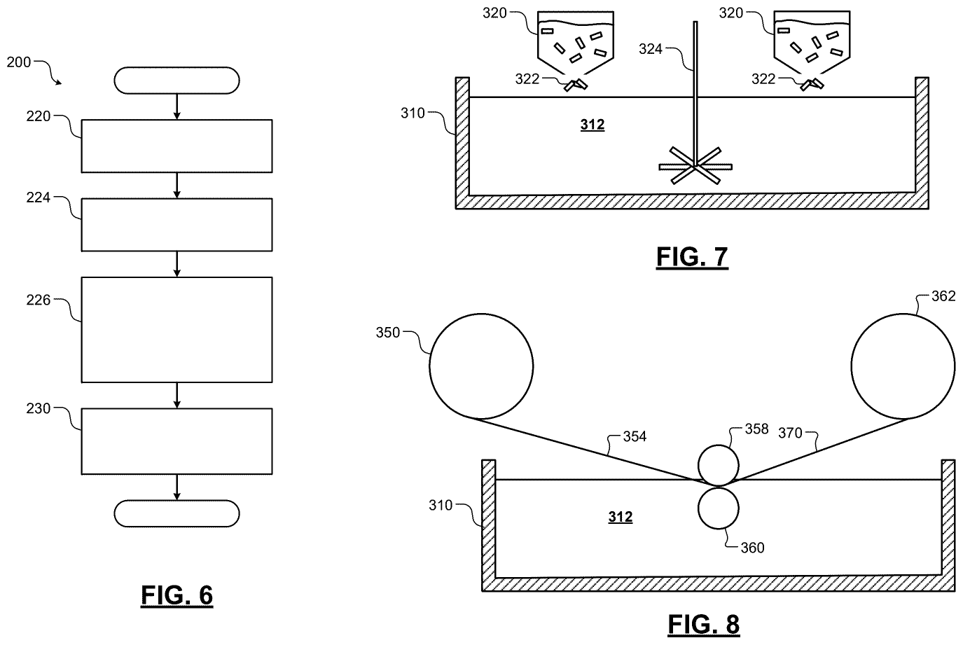

Referring now to FIG. 6, a method 200 for wetting an anode current collector using a bath including a molten lithium matrix with distributed copper particles is shown. At 220, the lithium is melted in a bath at a temperature that is at least 100° C. greater than a melting temperature of lithium (e.g., 270° C. (=170° C.+100° C.)). At 224, copper is added to the bath up to the solubility limit of copper. At 226, additional copper is added to increase the copper concentration to a range from 5 wt % to 15 wt %. The added copper causes secondary phase formation (beyond the copper solubility limit) and prevents further dissolution of copper from the copper foil current collector. At 230, the copper foil current collector passes through the lithium-copper bath to coat the copper foil current collector with lithium-copper (e.g., forming the anode active material layer of the anode electrode).

Referring now to FIG. 7, an example of preparation of the molten lithium-copper bath is shown. Lithium metal is heated and melted in a bath 310. A source 320 supplies copper 322 into the lithium bath to form a molten lithium matrix including lithium metal and distributed copper particles 312 having secondary phase formation as described in FIG. 6. In some examples, the copper comprises copper foil, brass foil (Cu—Zn), and/or bronze foil (Cu—Sn). The copper introduced into the molten lithium bath dissolves into the molten lithium. The distributed copper particles reduce the surface tension of the molten Li. In some examples, the molten lithium is stirred using an electromagnetic stirrer 324 to provide homogenous mixing. In some examples, foil (including copper) added to the bath includes scrap material created during battery manufacturing (e.g., such as scrap copper foil produced when forming the external tabs 48 of the anode current collectors 46).

Referring now to FIG. 8, manufacturing of anode electrodes is shown. A copper foil current collector 354 is supplied by a roll 350. The copper foil current collector 354 passes between rollers 358, 360 in the bath 310 including a molten lithium matrix with lithium metal and distributed copper particles (at 312). The copper foil current collector 354 is coated in the bath and then an anode electrode 370 is collected onto a roll 362.

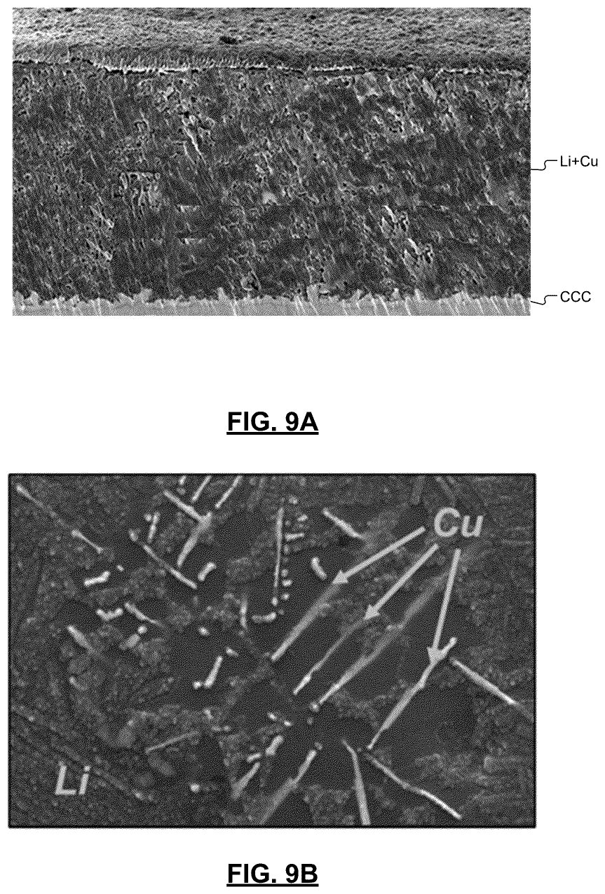

Referring now to FIGS. 9A and 9B, the copper from the lithium-copper bath forms an anode electrode including an active material layer with a 2-phase microstructure including a lithium matrix with lithium metal and homogeneously distributed copper particles. In FIG. 9A, a lithium-copper layer is formed on a copper current collector (CCC). The copper current collector passes through the lithium-copper bath. In some examples, some of the copper foil that is added to the molten lithium metal forms dendrite-like copper portions in the lithium-copper layer as shown in FIG. 9B. In other words, the copper dendrites form a 3-D current collector within the lithium metal.

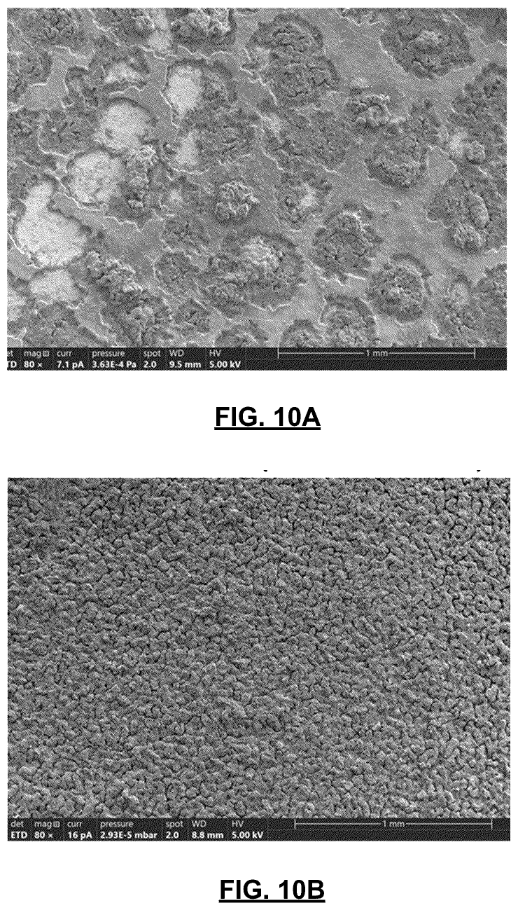

Referring now to FIGS. 10A and 10B, a microstructure of the lithium-copper layer is compared to a lithium foil/copper foil laminate after 50 cycles of stripping and plating. In FIG. 10A, a lithium layer formed by calendaring a lithium foil layer onto a copper foil current collector is shown. Lithium dendrites have formed after the cycling.

In FIG. 10B, the lithium-copper layer is formed by coating the copper foil current collector using the lithium-copper bath as described herein. As can be appreciated, the in-situ Cu particles and/or dendrites in the lithium-copper layer appear to be beneficial for more uniform lithium stripping and plating. In other words, the in-situ Cu particles and/or dendrites may reduce the formation of lithium dendrites during cycling.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is

1. A method for manufacturing an anode electrode for a battery cell, comprising:
melting lithium metal in a bath to create molten lithium metal;
adding copper to the molten lithium metal in the bath to form a molten lithium matrix including lithium metal and distributed copper particles,
wherein a concentration of the copper added to the bath comprises 5 wt % to 15 wt %; and
coating a copper current collector using the molten lithium matrix to form an anode active material layer on the copper current collector.

2. The method of claim 1, further comprising stirring the molten lithium matrix to create a homogenous mixture.

3. The method of claim 2, further comprising stirring the molten lithium matrix using an electromagnetic stirrer.

4. The method of claim 1, wherein the anode electrode has a thickness that is less than 70 μm.

5. The method of claim 1, wherein the anode electrode has a width greater than 100 μm.

6. The method of claim 1, further comprising heating the bath to a temperature that is at least 100° C. greater than a melting temperature of lithium.

7. The method of claim 6, wherein the temperature of the bath is in a range from 290° C. to 310° C.

8. The method of claim 1, wherein the copper added to the bath is selected from a group consisting of copper foil, bronze foil, brass foil, and combinations thereof.

9. The method of claim 1, wherein the copper added to the bath includes copper foil.

10. The method of claim 1, wherein the copper current collector does not include a lithiophilic metallic/metal-oxide coating.

11. An anode electrode for a battery cell, comprising:
an anode current collector comprising copper; and
an anode active material layer coated onto an outer surface of the anode current collector,
wherein the anode active material layer comprises a lithium matrix including lithium metal and distributed copper particles,
wherein the copper in the anode active material layer comprises 5 wt % to 15 wt % of the anode active material layer.

12. The anode electrode of claim 11, wherein the distributed copper particles form copper dendrites in the lithium metal of the anode active material layer.

13. The anode electrode of claim 11, wherein:
the anode electrode has a thickness that is less than 70 μm, and
the anode electrode has a width greater than 100 μm.

14. The anode electrode of claim 11, wherein the anode current collector comprises copper foil.

15. The anode electrode of claim 11, wherein the anode current collector does not include a lithiophilic metallic/metal-oxide coating.

16. A battery cell for a vehicle, comprising:
A of the anode electrode of claim 11;
C cathode electrodes; and
S separators, where A, C and S are integers greater than one.

17. A method for manufacturing an anode electrode for a battery cell, comprising:
heating lithium metal in a bath to create molten lithium metal at a temperature that is at least 100° C. greater than a melting temperature of the lithium metal;
adding copper to the molten lithium metal in the bath to form a lithium matrix including distributed copper particles,
wherein the copper comprises in a range from 5 wt % to 15 wt % of the lithium matrix; and
stirring the lithium matrix in the bath using an electromagnetic stirrer; and
coating a copper current collector using the lithium matrix in the bath to form an anode active material layer on the copper current collector,
wherein the anode electrode has a thickness that is less than 70 μm and a width greater than 100 μm.

18. The method of claim 17, wherein the temperature is in a range from 290° C. to 310° C.

19. The method of claim 17, wherein the copper added to the bath is selected from a group consisting of copper foil, bronze foil, and brass foil.
